(19) United States
(12) Patent Application Publication
(10) Pub. No.: US 2018/0357520 A1
(43) Pub. Date: Dec. 13, 2018

(54) PROTECTIVE SYSTEM FOR INFRARED LIGHT SOURCE

(71) Applicant: Seeing Machines Limited, Braddon (AU)

(72) Inventor: Timothy Edwards, O'Connor (AU)

(21) Appl. No.: 15/579,859

(22) PCT Filed: Jun. 3, 2016
(86) PCT No.: PCT/AU2016/050452

§ 371 Date: Dec. 5, 2017

(30) Foreign Application Priority Data
Jun. 5, 2015 (AU) 2015902250

(51) Int. Cl. G06K 9/78; G06K 9/00; G06K 9/20; G06T 7/50

(52) U.S. Cl. CPC G06K 9/78; G06K 9/00832; G06T 2207/30201; G06T 7/50; G06T 2207/10048; G06K 9/2027

(57) ABSTRACT

Described herein are systems and methods for controlling the output power of an LED light source. One embodiment relates to a monitoring system including: a camera (201) for capturing images of a person's face, including the person's eyes; one or more infrared light sources (204, 206) for illuminating the person's face during a period in which the images are captured; and a controller for processing the captured images to determine information about the person's eyes or face and for controlling the output power of the one or more infrared light sources upon detection of a monitoring signal indicative of the proximity of a part of the person from the one or more infrared light sources.

### FIELD OF THE INVENTION

The present application relates to a control system and in particular to a control system for one or more illumination sources.

Embodiments of the present invention are particularly adapted for controlling the power of an infrared illumination source in a driver monitoring system. However, it will be appreciated that the invention is applicable in broader contexts and other applications.

### BACKGROUND

Electromagnetic radiation is a form of energy which can be thought of as a light, a wave or tiny packets of energy which move through space. Referring to FIG. 1, Electromagnetic waves comprise a continuous spectrum of frequencies, which can be characterized into discrete bands ranging from low frequency ranges such as radio waves 101, to high frequencies 102 such as X-rays 106.

Generally, in the middle of that range are wavelengths which make up the visible light spectrum 103, which are the colors red to violet that human beings can see. Infra” means “below” and infrared waves 104 are just below the visible red light area in the electromagnetic spectrum, having lower frequencies and longer wavelengths than visible waves.

Higher frequency radiation has more energy and can interact more strongly with matter that it encounters. For example, people can be constantly exposed to radio waves 101 with no ill effects but even a relatively brief exposure to X-rays 106 can be hazardous.

Infrared radiation has a range of frequencies or wavelengths, with “near infrared” being the closest in wavelength to visible light, and “far infrared” closer to the microwave region 107 and having lower frequencies (longer wavelengths) than the near infrared. Near infrared waves are short in wavelength and cooler compared to far infrared wavelengths, and are sometimes unnoticed by humans. Infrared waves are related to heat in that matter having thermal energy includes moving particles which emit thermal radiation at frequencies across the electromagnetic spectrum. Matter having very high temperatures emits thermal radiation primarily in the higher frequency end of the electromagnetic spectrum while matter at relatively warm temperatures (by human standards) emits thermal radiation primarily in the infrared spectrum. Infrared wavelengths can be felt as warmth on the skin, but generally do little harm or damage to matter or tissue. Infrared waves are given off by bodies such as lamps, flames and anything else that's warm including humans and other living things.

Infrared emitting and sensing technology is used in many areas. Infrared light emitting diodes (LEDs) are often used to treat sports injuries and burns as infrared light is able to pass through up to an inch of tissue. Physiotherapists use Infrared LEDs or heat lamps to help heal sports injuries.

Infrared LEDs are also used in remote controls for TVs and video recorders. Infrared radiation is also used for short-range communications, for example between mobile phones, or for wireless headset systems. Infra red LEDs are used in cameras to focus on subjects of interest. Weather forecasters use infrared cameras in satellites, because they show cloud and rain patterns more clearly.

Apart from remote controls and cameras, common modern uses for infrared radiation sensing include security systems, night vision devices and facial detection and recognition systems. Infrared detectors are used in burglar alarm systems, and to control security lighting. A detector picks up infrared radiation emitted from a human's or animal's body. Police helicopters can track criminals at night, using thermal or infrared imaging cameras that can see in the dark. These cameras detect infrared waves instead of visible light. Similar cameras are also used by fire crews and other rescue workers, to find people trapped in rubble. Infrared cameras are also used in systems that perform facial detection, facial recognition and facial feature recognition.

Various systems utilizing infrared sensors may rely directly on infrared radiation present in the scene being detected (say, by a person who emits thermal radiation). However, in many applications, one or more infrared emitters are used to emit infrared radiation into the scene which can be reflected and imaged by an infrared sensor. Such a scenario is utilized in driver monitoring systems, which utilize one or more infrared light sources such as LEDs to emit infrared radiation onto a face of a vehicle driver. The reflected infrared radiation is sensed by an infrared camera as images, which are processed to sense driver drowsiness and/or attention levels. The non-visual nature of the infrared radiation does not distract the driver during operation of the vehicle. In these driver monitoring systems, the infrared LEDs are typically located about 30 centimeters to 1 meter from the driver's face.

Generally, unlike more powerful forms of electromagnetic energy, infrared radiation typically only has enough energy to start molecules moving and not to break them apart or cause tissue damage. When a person's tissue absorbs infrared light, the consequence is usually that a person feels warmth in the area exposed. Since infrared radiation works to get molecules moving, a moderate dose of infrared radiation will simply heat up any living tissue it is close to, that it radiates to or touches.

In some cases though, infrared radiation can be hazardous in that a prolonged exposure to a high level of infrared radiation could result in a burn, similar to exposure to a hot stove, another heat source or a long exposure period to the sun. The danger to people from too much infrared radiation is caused by overheating of tissues which can lead to skin burns. Skin exposed to infrared radiation generally provides a warning mechanism against the thermal effects. People may feel pain, but depending on the level of infrared exposure, the pain may not be immediately forthcoming with the exposure.

Protection against UV (and other harmful electromagnetic) rays may be achieved by administrative control measures such as limiting exposure times for employees in hazardous environments. Additionally personal protective equipment such as protective clothing may be used. However, in applications such as driver monitoring, where continuous or near-continuous illumination of a driver by infrared radiation is advantageous, these measures might be impractical and the inventor has identified that other solutions need to be found.

Any discussion of the background art throughout the specification should in no way be considered as an admission that such art is widely known or forms part of common general knowledge in the field.

### SUMMARY OF THE INVENTION

The preferred embodiments of the invention aim to offset the drawbacks of using an infrared light source in particular applications. Using a detection device makes it possible to detect obstacles within the proximity of the infrared light or illumination source. LEDs or light source devices are switched off or the power to the LED or light source is reduced when a human or other object is detected to be too close to the LED or light source. Some examples include the use of an infrared light source in a facial detection/recognition/tracking system or an eye detection/recognition/tracking system.

In accordance with a first aspect of the present invention, there is provided a monitoring system including:

a camera for capturing images of a person's face, including the person's eyes;

one or more infrared light sources for illuminating the person's face during a period in which the images are captured; and

a controller for processing the captured images to determine information about the person's eyes or face and for controlling the output power of the one or more infrared light sources upon detection of a monitoring signal indicative of the proximity of a part of the person from the one or more infrared light sources.

In some embodiments the monitoring signal is obtained from a proximity detection device located proximate to one of the one or more infrared light sources. In one embodiment, the proximity detection device includes a sensor configured to detect radio frequency (RF) electromagnetic waves. The system preferably further includes an oscillator configured to emit RF electromagnetic radiation for detection by the sensor. The person is preferably a driver of a vehicle and the oscillator is preferably embedded within a driver's seat of the vehicle and configured to pass the emitted RF electromagnetic radiation through the driver, who re-radiates the RF electromagnetic radiation for detection by the sensor.

In other embodiments the monitoring signal is derived by the controller from depth information of the part of the person extracted from the captured images. In some embodiments the depth information is derived from a measure of the brightness of the part of the person in the images. In one embodiment the brightness is determined from a brightness-distance model. In another embodiment the depth information is derived from phase information captured by the camera. Preferably the camera is capable of capturing images in three dimensions and the depth information is extracted from the three dimensional images by the controller.

In some embodiments the controller is responsive to the monitoring signal to set the output power of the one or more infrared light sources to one of a plurality of power output levels based on the proximity of the part of the person from the one or more infrared light sources. In one embodiment the output power levels are determined by an illumination model. In another embodiment the output power levels are determined by a lookup table stored in a database.

In one embodiment the controller is responsive to the monitoring signal to issue an alert if the part of the person comes within a predetermined proximity from the one or more infrared light sources.

The part of the person preferably includes the person's face, eyes, hands or arms.

The output power is preferably controlled based on a determination of radiation safety to the person.

In one embodiment the eye tracking system is fitted within a vehicle cabin and the person is a driver of the vehicle.

In accordance with a second aspect of the present invention, there is provided a method of controlling an LED, the method including, detecting a proximity of an object from the LED; and based on the detected proximity, selectively setting the output power of the LED to one of a plurality of predefined power levels.

In accordance with a third aspect of the present invention, there is provided an illumination system including:
one or more infrared light sources;
a controller for controlling the output power of the one or more infrared light sources; and
one or more proximity detection devices positioned proximal to the one or more infrared light sources and being in electrical communication with the controller, each of the one or more proximity detection devices configured to detect the proximity of an object and, in response, issue a respective monitoring signal to the controller;
wherein, in response to receiving the monitoring signal, the controller selectively adjusts the output power of the one or more infrared light sources.

In one embodiment the one or more proximity detection devices include a proximity detection device. In another embodiment the one or more proximity detection devices include a camera having range estimation capability.

### BRIEF DESCRIPTION OF THE FIGURES

Example embodiments of the disclosure will now be described, by way of example only, with reference to the accompanying drawings in which:

FIG. 1 illustrates the electromagnetic spectrum and its primary sub-bands;

FIG. 2 is an illustration of a driver's perspective view of an automobile dashboard having a driver monitoring system including a camera and two LED light sources installed therein;

FIG. 3 is a schematic plan view of the driver monitoring system of FIG. 2 showing caution zones corresponding with each light source;

FIG. 4 is a schematic plan view of a driver monitoring system according to a first embodiment of the invention, including proximity detection devices adjacent each LED for providing feedback to control the output power of the LEDs;

FIG. 5A is a schematic illustration showing two hands; one located within a caution zone of an LED and one located outside the caution zone;

FIG. 5B is a schematic illustration of an LED light source and associated caution zone and a proximity detection device with its associated threshold area;

FIG. 6 is a schematic plan view of a driver monitoring system according to a second embodiment of the invention, including a single proximity detection device and two LEDs;

FIG. 7 is a schematic plan view of driver monitoring system according to a third embodiment of the invention, including two illuminating LEDs and a camera capable of determining depth/range of objects within a field of view and feedback to control the LEDs based on the measured depth/range; and

FIG. 8 is a flowchart of a method of controlling a light source based on the proximity of detected objects.

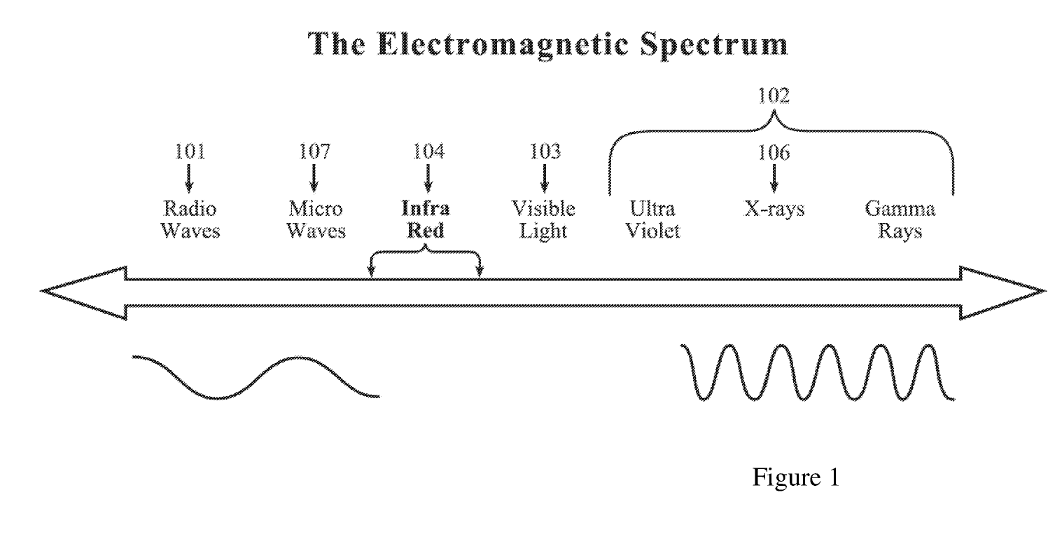

### DESCRIPTION OF THE INVENTION

The protective system described herein may be applied and used in a multitude of environments. One example is monitoring a driver or passengers of an automobile or for example, other vehicles such as a bus, train or airplane. Additionally, the described system may be applied to an operator using or operating any other equipment, such as machinery or in a specific example, an aircraft control person. For ease of understanding, the embodiments of the invention are described herein within the context of a driver monitoring system for a vehicle.

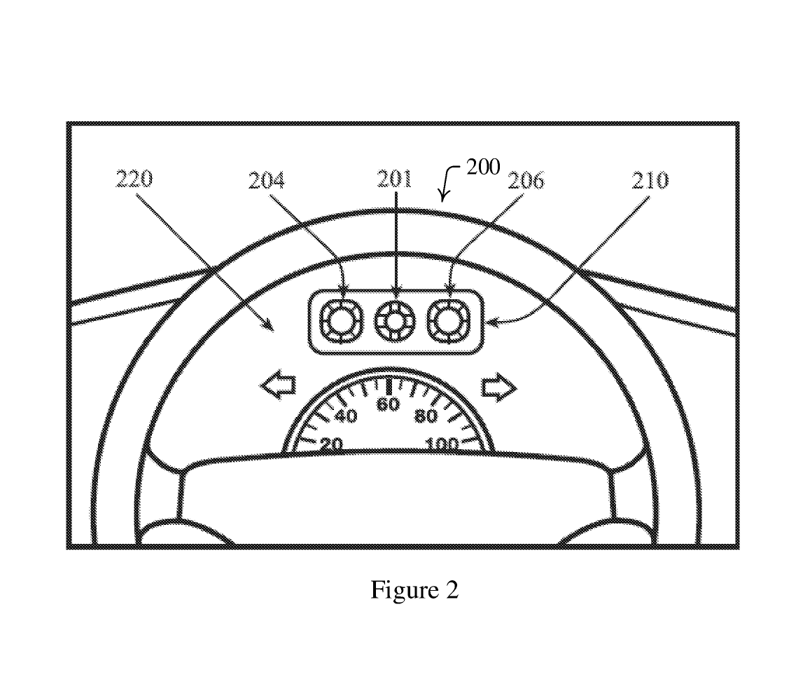

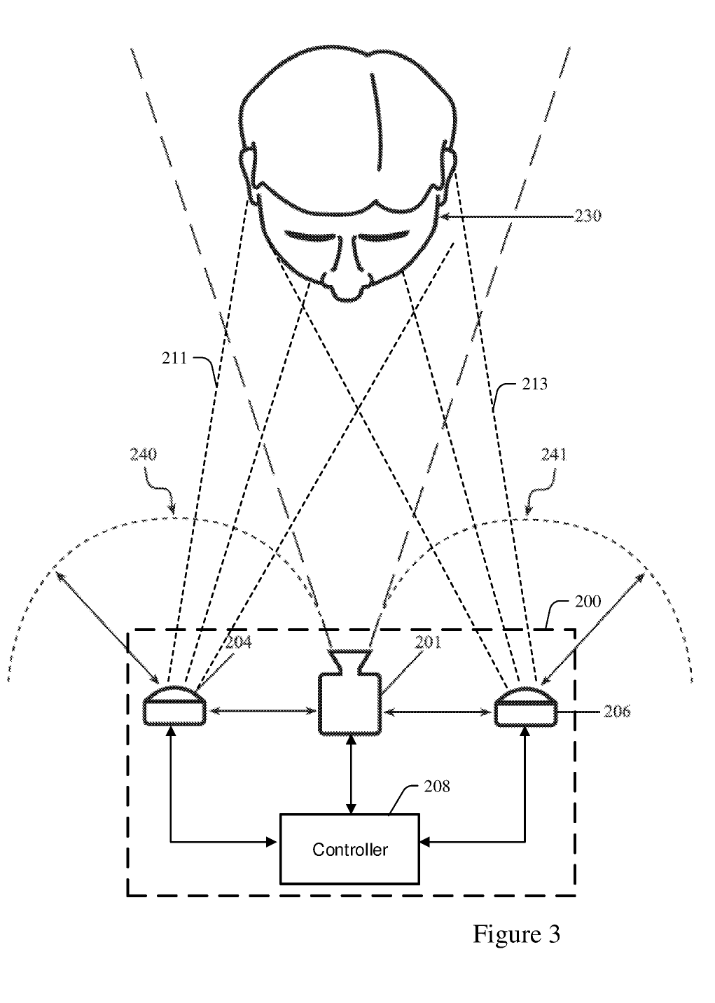

Referring initially to FIGS. 2 and 3, there is illustrated a driver monitoring system 200 for capturing images of a vehicle driver 230 during operation of the vehicle. System 200 is further adapted for performing various image processing algorithms on the captured images such as facial detection, facial feature detection, facial recognition, facial feature recognition, facial tracking or facial feature tracking, such as tracking a person's eyes. Example image processing routines are described in U.S. Pat. No. 7,043,056 to Edwards et al. entitled “Facial Image Processing System” and assigned to Seeing Machines Pty Ltd, the contents of which are incorporated herein by way of cross-reference. System 200 includes an imaging camera 201 orientated to generate images of the driver's face to identify, locate and track one or more human facial features. Camera 201 may be a conventional CCD or CMOS based digital camera having a two dimensional array of sensors and optionally the capability to determine range or depth (such as through one or more phase detect elements). Camera 201 may also be a three dimensional camera such as a time-of-flight camera or other scanning or range-based camera capable of imaging a scene in three dimensions.

System 200 also includes a pair of infrared light sources in the form of light emitting diodes (LEDs) 204, 206, horizontally symmetrically disposed at respective positions proximate to the camera. LEDs 204, 206 are adapted to illuminate driver 230, during a time when camera 201 is capturing an image, sufficiently enough to obtain acceptable camera images of the driver's face or facial features. LEDs 204, 206 may be operated continuously, intermittently or periodically and may be operated alternatively in a strobed fashion which provides operational advantages in reducing glare present in the images. Operation of camera 201 and LEDs 204, 206 is controlled by an associated controller 208 which comprises a computer processor or microprocessor and memory for storing and buffering the captured images from camera 201. In other embodiments, different types of light sources may be used in place of LEDs.

Referring specifically to FIG. 2, in one embodiment, imaging camera 201 and light sources 204, 206 may be manufactured or built as a single unit 210 or common housing containing a single light source or a plurality of two or more light sources 204, 206. The camera and light source unit 210 is shown installed in a vehicle dash board 220 and may be fitted during manufacture of the vehicle or installed subsequently as an after-market product. In other embodiments, the driver monitoring system may include one or more cameras mounted in any location suitable to capture images of the head or facial features of a driver, subject and/or passenger in a vehicle. Also, less than or more than two light sources may be employed in the system. In the illustrated embodiment, the first and a second light source each include a single LED. In other embodiments, each light source may each include a plurality of individual LEDs.

In the illustrated embodiment, a single unit 210 containing a camera and two LED light sources is used, with the LEDs spaced apart horizontally by a distance in the range of about 2 cm to 10 cm. The single unit 210 may be placed in a dashboard or mounted on a steering column, conveniently positioned to view a driver's face and sufficiently positioned to capture images of the region where a subject (e.g., driver's head) is expected to be located during normal driving. The imaging camera captures at least a portion of the drivers head, particularly the face including one or both eyes and the surrounding ocular features. The eyes may be tracked in the images, for example, to detect gaze direction or gather information about the driver's eyes including blink rate or eye closure to detect sleepiness or other issues that may interfere with the driver safely operating the vehicle. In alternative embodiments, light sources may be placed at other locations or various positions to vary the reflective angles between the light sources, a driver's face and the camera. For example, cameras and LEDs may be located on a rearview mirror, center console or driver's side A-pillar of the vehicle.

Additional components of the system may also be included within the common housing or may be provided as separate components according to other additional embodiments. In one embodiment, the operation of controller 208 is performed by an onboard vehicle computer system which is connected to camera 201 and LEDs 204, 206.

Referring specifically to FIG. 3, LEDs 204, 206 illuminate driver 230 with infrared radiation 211, 213 to obtain acceptable camera images of the driver's face or facial features. Generally, but not necessarily the LEDs 204, 206 are infrared LEDs. In a typical circumstance using the dash mounted system 200, the vehicle driver is generally far enough away from the infrared LEDs 204, 206 such that there are no infrared hazards or dangers to the driver 230. In these applications, the driver is approximately 80 cm to 150 cm away from the camera 201 and the infrared LEDs 204, 206. In some embodiments, each LED is separated from the camera by at least 5 cm to facilitate improved tracking or system performance in relation to glare noise.

However, if any part or portion of the driver 230 is positioned too close or within a short distance from the infrared LEDs 204, 206, there may be a safety concern. In this case, there may be enough power density light or energy emitted by the infrared LEDs to warm or burn human tissue, which may be similar to a strong exposure to the sun on a clear day.

The distance from or the area around the infrared LEDs where there may be a safety concern will be referred to as a “caution zone” 240, 241, as illustrated in FIG. 3. The size or distance of the caution zone varies depending upon several factors that include but are not limited to an average or peak power level for each infrared LED, the frequency emitted by the LED and whether there are surfaces or objects close to the infrared LED that reflect infrared energy. A caution zone or distance is typically less than 10 cm from the infrared LED. However, for a powerful infrared LED or powerful light source, the distance may be in the range of 15 cm or even greater.

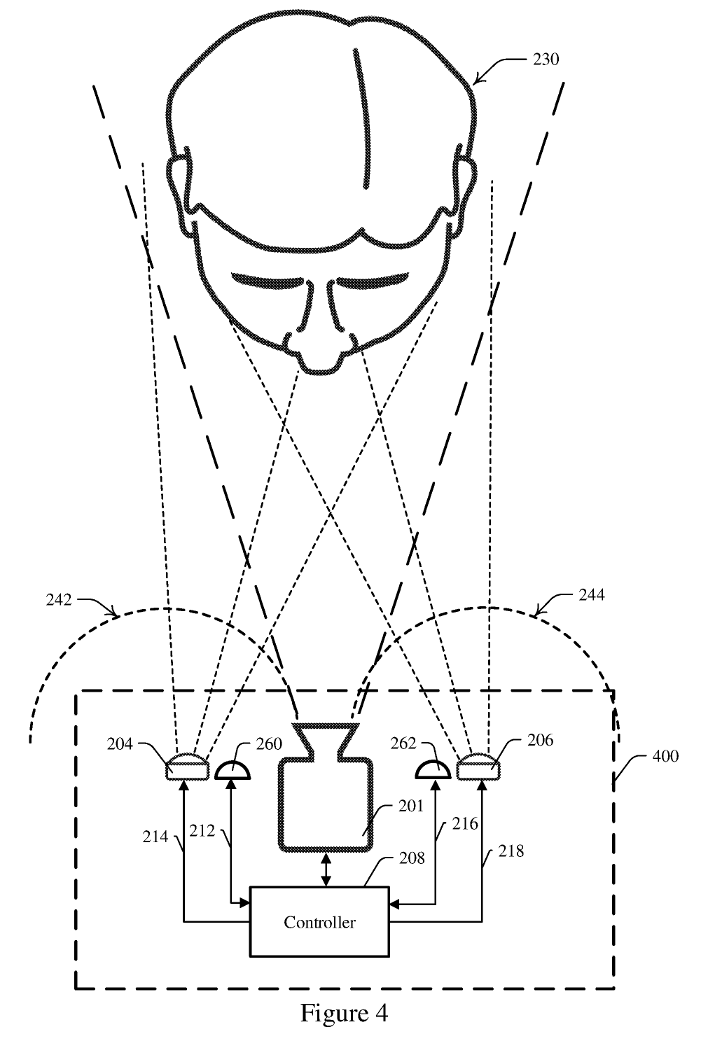

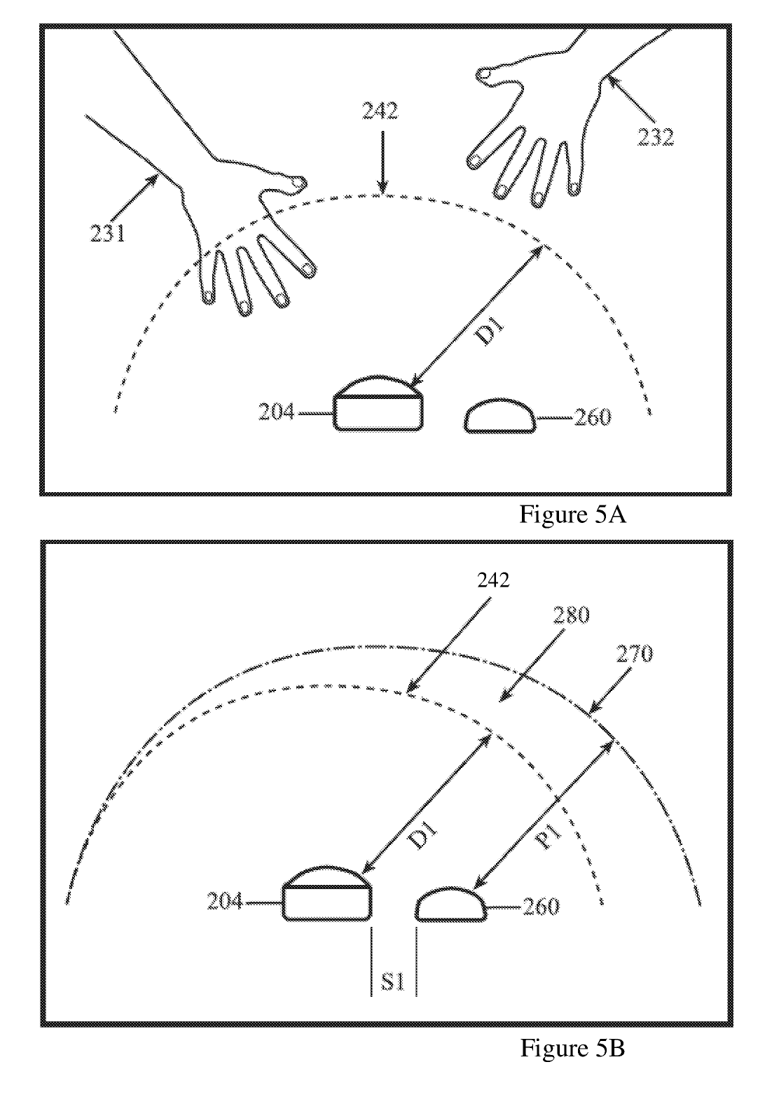

In the present invention, the distance between the LEDs and the driver is monitored and a feedback control signal is used by controller 208 to control the output power of the LEDs based on the detected distance. In a first embodiment of the invention illustrated in FIGS. 4 and 5, a driver monitoring system 400 includes a pair of proximity detection devices 260, 262, each of which is co-located or proximately located to respective infrared LEDs 204, 206 to monitor the distance between the driver and LEDs and provide feedback to control the output power of the LEDs. In system 400, corresponding elements of system 200 are designated with like reference numerals. The proximity detection devices 260, 262 comprise either single components or part of a proximity detection system and preferably include known proximity sensors including, for example, capacitive sensors, photoelectric sensors, sonar or ultrasonic sensor. The proximity detection devices may measure a simple one dimensional range or may be more sophisticated to measure the relative position of objects in two or three dimensions. The proximity detection devices are in electrical communication with controller 208 as illustrated in FIG. 4.

In system 400, the proximity detection device 260 262 represent separate devices which are simply located proximate to corresponding infrared LEDs 204 206. However, it will be appreciated that, in other embodiments, the proximity detection devices may be co-located or integrated with the corresponding infrared LEDs into individual modules.

In operation, proximity detection devices 260, 262 are configured to detect objects within a pre-determined or a dynamically configured caution zone. FIGS. 5A and 5B illustrate an exemplary caution zone 242 for proximity detection device 260 associated with LED 204. As illustrated, caution zone 242 is preferably hemispherical having a radius D1 which defines a surface of constant distance from proximity detection device 260 in a forward direction of illumination of LED 204. However, in other embodiments the caution zones may be spherical to detect the proximity of objects isometrically in all directions.

As each proximity detection device is located proximal to its associated LED, the caution zone roughly approximates a safe zone around the LED. Referring again to FIG. 5B, a predetermined proximate distance S1 between infrared LED 204 and proximity detection device 260 is shown. The infrared LED 204 is shown having a corresponding caution zone 242 with radius D1. Also, the proximity detection device 260 is shown having a corresponding detection or threshold area 270 with radius P1. An error or erroneous area 280 results from the location difference S1 between the infrared LED 204 and the proximity detection device 260. Provided that the detection area 270 is greater than the caution zone related to the infrared LED and the detection area 270 is a superset of the caution zone 242, the proximity detection device 260 still functions to mitigate any safety hazard within the caution zone 242. In a preferred application, embodiment or implementation, the distance S1 is approximately or less than 1 cm.

Referring again to FIG. 4, proximity detection device 260 monitors detection zone 242 and issues a respective monitoring signal 212 to controller 208. If an object is detected within the caution zone 242, controller 208 will function to turn off infrared LED 204 or reduce the power output of LED 204 by issuing a control signal 214 in response to the monitoring signal 212. A similar process occurs for LED 206 and proximity detection device 262 having a caution zone 244, which sends a monitoring signal 216 to controller 208, which, in turn, sends a control signal 218 to LED 262.

By way of example, referring to FIG. 5A, if a driver's hand 232 is detected to be outside of caution zone 242, there is little or no safety hazard and infrared LED 204 remains on or in an illumination state or mode. When the driver's hand 231 is placed within the caution zone 242 or too close to the infrared LED 204, the proximity detection device 260 will issue monitoring signal 212 to controller 208, which will in turn send control signal 214 to LED 204 to turn LED 204 off or reduce its output power thus mitigating the infrared LED 204 safety concern. When the person's hand 232 is removed from the caution zone 242, the proximity detection device will issue monitoring signal 212 to controller 208 which will in turn send a new control signal 214 to LED 204 to turn LED 204 back on or adjust the output power to a predetermined illumination state or mode. Optionally, a warning tone, alarm, or other alert that corresponds with an object or driver's hand approaching or breaching a caution zone or the removal of an object or person's hand may be implemented.

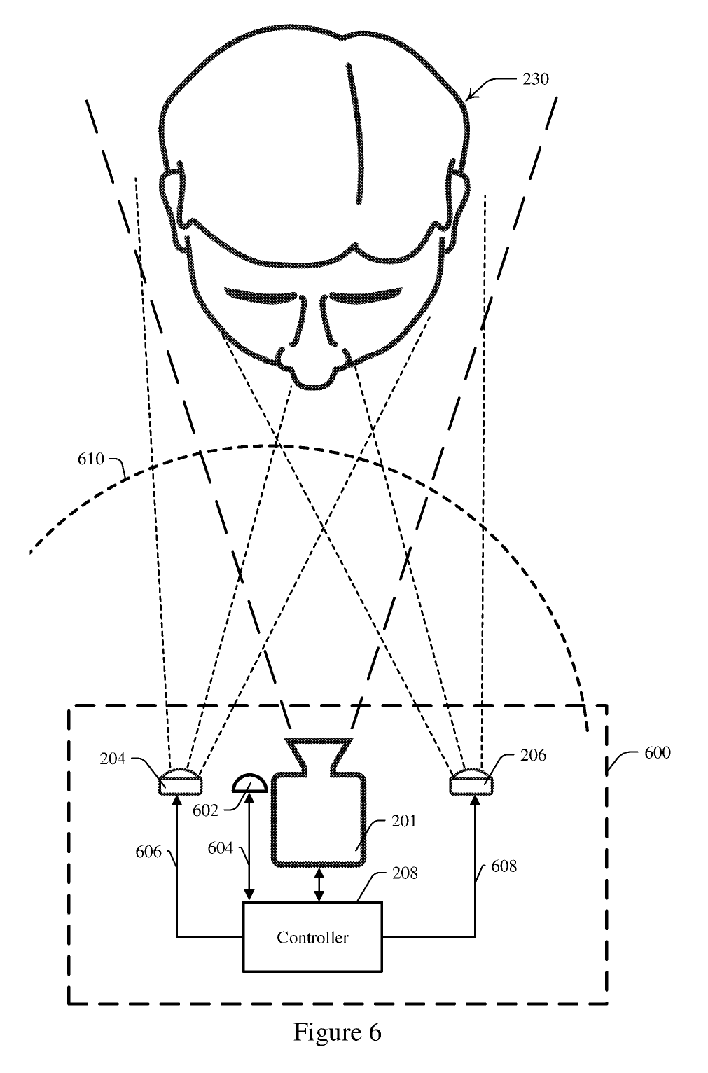

In system 400, each LED is paired with a corresponding proximity detection device. However, in alternative embodiments, a single proximity detection device may be associated with multiple LEDs. Referring now to FIG. 6, there is illustrated an alternative driver monitoring system 600, in which corresponding elements of system 400 are designated with like reference numerals. System 600 includes only a single proximity detection device 602. The operation of system 600 is similar to that of system 400 with the exception that the output power of both LEDs 204 and 206 is controlled by a single proximity detection device 602 in conjunction with controller 208. In operation, proximity detection device 602 monitors the proximity of objects and issues a monitoring signal 604 to controller 208. In response to monitoring signal 604, controller issues control signals 606 and 608 to respective LEDs 204 and 206. When an object is detected within a caution zone 610, monitoring signal 604 triggers controller 208 to issue control signals 606 and 608 to LEDs 204 and 206 to either switch off the LEDs or reduce the power of the LEDs for a predetermined period of time.

The system operation described above is essentially binary in which LED control is either in a high power state or a lower power state (or switched off entirely) based on the detection of an object within a caution zone. In other embodiments, a more dynamic control of the LEDs is provided wherein the output power of the LEDs is controlled to within a plurality of power levels by controller 208 in response to the detection of objects within one of a plurality of predetermined ranges defined by the proximity detection devices. In essence, the proximity detection devices are capable of measuring a range to an object and this range information is included in the respective monitoring signals sent to controller 208. The respective control signals sent to the LEDs by controller 208 include a plurality of power levels at which the LED should be driven based on the detected range to the object.

By way of example, control of the LED power based on detected range is determined by a lookup table of ranges and corresponding LED drive currents stored in memory associated with controller 208. An exemplary lookup table including 6 range bins is included below.

| Range detected | LED drive current | LED output power |
|---|---|---|
| <5 cm | 0 mA | 0 mW |
| 5 cm-8 cm | 10 mA | 50 mW |
| 8 cm-10 cm | 15 mA | 75 mW |
| 10 cm-15 cm | 20 mA | 100 mW |
| 15 cm-20 cm | 25 mA | 125 mW |
| >20 cm (or no | 30 mA | 150 mW |
| detection of objects) | | |

The number of range bins used and the appropriate LED drive currents for each range bin are determined by controller and may be programmed by a user of the system. In another embodiment, the required drive current or output power is derived from an illumination model which takes range data as an input. The illumination model may be derived from data indicative of radiation safety of a person.

In another embodiment (not illustrated), the proximity detection device or devices include a sensor or antenna configured to detect radio frequency (RF) electromagnetic waves emitted from an oscillator embedded in the driver's seat of the vehicle. The emitted RF waves enter the drivers body while sitting in the driver's seat and cause the body to re-radiate energy at a predefined RF frequency. The oscillator also encodes or modulates the RF waves so as to disambiguate it from any other potential radio sources at the same or similar frequencies. The proximity detection device takes the form of a small receiver disposed adjacent to the LEDs and the range from any of the driver's body parts can be determined based on the power of the received encoded RF radiation component. The range can be extracted from the detected power by way of a predefined relationship. By way of example, if the driver's body is assumed to emit the RF radiation isotropically, the range can be extracted by the inverse square law:

$$Power ∝ \frac{1}{{range}^{2}} .$$

If the driver's body is assumed to emit the RF radiation in a directional pattern (such as an antenna), more complex relationships between power and distance can be used. In the power/range calculations, the power loss in passing through the vehicle seat, the driver, the antenna and associated cabling must be accounted for.

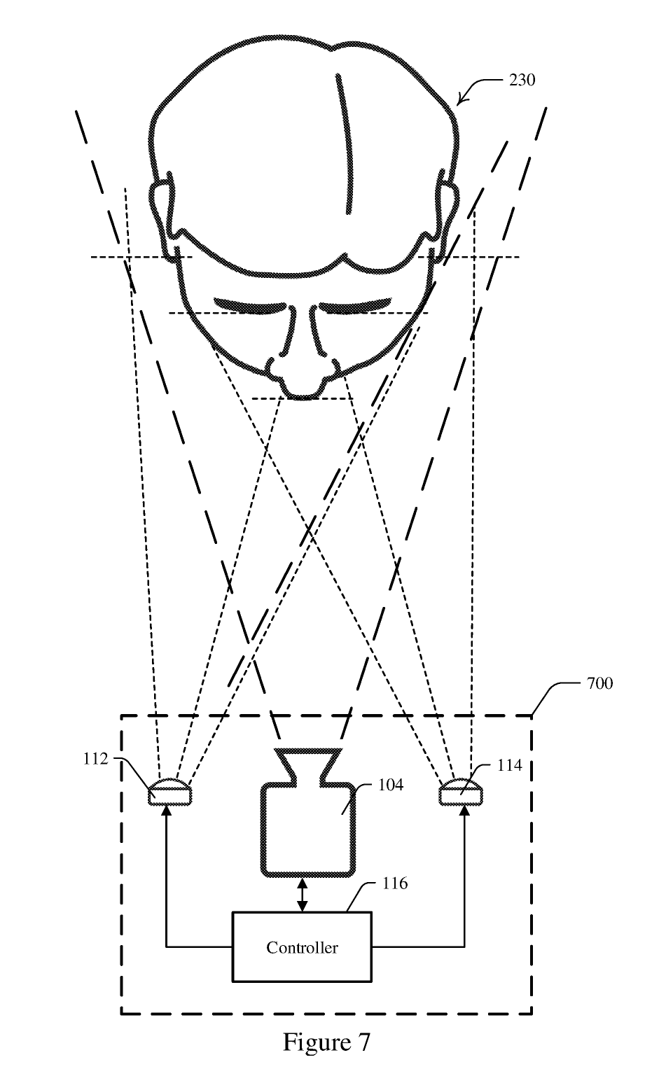

In additional configurations or embodiments, camera 201 or a separate camera is used to measure an object or person's proximity to an infrared LED light source. Referring now to FIG. 7, there is illustrated a further driver monitoring system 700 wherein corresponding features of systems 400 and 600 are designated with like reference numerals. In system 700, no proximity detection devices are used and range to an object is determined from the images captured by camera 201.

In one embodiment using system 700, controller 208 processes the captured images to determine a brightness level of imaged objects and, as a person or object moves closer to a camera 110, 201, the person or object thus moves closer to corresponding light sources 204, 206 proximately located to the camera 201. As the person or object moves closer to the camera and light sources, the amount of light reflected from the person or object increases. The amount of reflected light or brightness is measured by controller 208 and compared with a brightness-distance model stored in memory to determine the person's or object's distance from the camera and light sources. In this configuration or embodiment, the camera or image brightness is used as a distance and proximity detector. Further options for this configuration or embodiment include adding a proximity detection device proximate to the camera to improve resolution capability or redundancy.

In further embodiments using system 700, distance to an object is determined by extracting depth information from the images captured by camera 201. In a first of these further embodiments, camera 201 is capable of capturing three dimensional images of a scene and a range/depth of an imaged object is extracted from these three dimensional images by controller 208. Examples of cameras capable of measuring three dimensional images include scanning or pulsed time of flight cameras. Depth information in an image can also be obtained from a single camera incorporating one or more phase detect elements or from a stereoscopic camera system including two cameras imaging a common field of view.

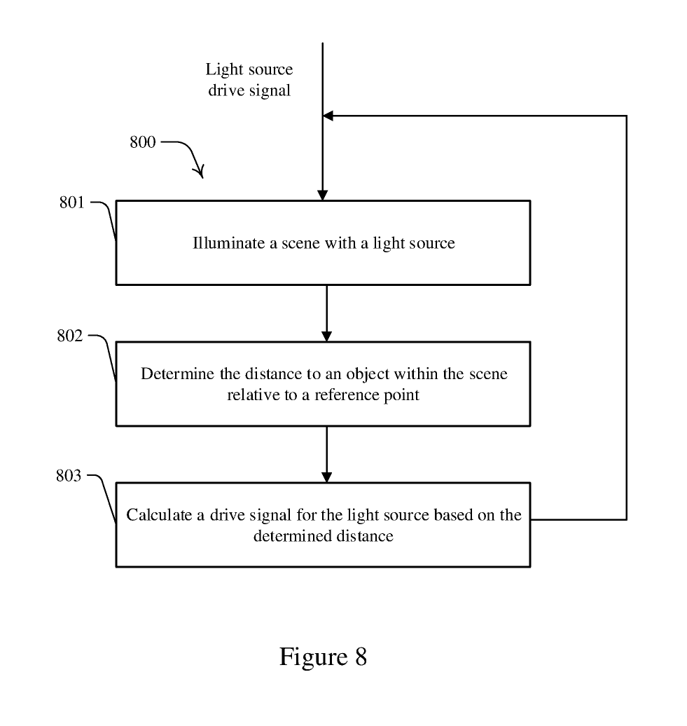

More broadly, the present invention applies to systems capable of performing a method 800 of controlling the output power of a light source based on proximity of detected objection, as illustrated in FIG. 8. At step 801, a scene of interest is illuminated with a light source such as an LED. At step 802, a controller determines the distance to an object such as a person within the scene relative to a reference point. The reference point may represent the light source itself or the position of an associated imaging camera or proximity detection device as described above. The distance determination may be performed by a proximity detection device, range sensor or camera as described above. At step 803, the controller calculates an appropriate drive signal for driving the light source at an appropriate power level based on the determined distance. The drive signal may represent either a drive current or a drive voltage. In one embodiment, the drive signal is controlled by varying the resistance of a variable resistor in a drive circuit of the light source. The calculated drive signal is fed to the light source and method 800 is repeated continuously, regularly or intermittently as required for the application.

### Interpretation

The term “infrared” is used throughout the description and specification. Within the scope of this specification, infrared refers to the general infrared area of the electromagnetic spectrum which includes near infrared, infrared and far infrared frequencies or light waves.

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “controller” or “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

Reference throughout this specification to “one embodiment”, “some embodiments” or “an embodiment” means that a particular feature, structure or characteristic described in connection with the embodiment is included in at least one embodiment of the present disclosure. Thus, appearances of the phrases “in one embodiment”, “in some embodiments” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

It should be appreciated that in the above description of exemplary embodiments of the disclosure, various features of the disclosure are sometimes grouped together in a single embodiment, Fig., or description thereof for the purpose of streamlining the disclosure and aiding in the understanding of one or more of the various inventive aspects. This method of disclosure, however, is not to be interpreted as reflecting an intention that the claims require more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

In the description provided herein, numerous specific details are set forth. However, it is understood that embodiments of the disclosure may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical, electrical or optical contact, or that two or more elements are not in direct contact with each other but yet still co-operate or interact with each other.

Embodiments described herein are intended to cover any adaptations or variations of the present invention. Although the present invention has been described and explained in terms of particular exemplary embodiments, one skilled in the art will realize that additional embodiments can be readily envisioned that are within the scope of the present invention.

1. A monitoring system including:
a camera for capturing images of a person's face, including the person's eyes;
one or more infrared light sources for illuminating the person's face during a period in which the images are captured; and
a controller for processing the captured images to determine information about the person's eyes or face and for controlling the output power of the one or more infrared light sources upon detection of a monitoring signal indicative of the proximity of a part of the person from the one or more infrared light sources.

2. The monitoring system according to claim 1 wherein the monitoring signal is obtained from a proximity detection device located proximate to one of the one or more infrared light sources.

3. The monitoring system according to claim 2 wherein the proximity detection device includes a sensor configured to detect radio frequency (RF) electromagnetic waves.

4. The monitoring system according to claim 3 including an oscillator configured to emit RF electromagnetic radiation for detection by the sensor.

5. The monitoring system according to claim 4 wherein the person is a driver of a vehicle and the oscillator is embedded within a driver's seat of the vehicle and configured to pass the emitted RF electromagnetic radiation through the driver, who re-radiates the RF electromagnetic radiation for detection by the sensor.

6. The monitoring system according to claim 1 wherein the monitoring signal is derived by the controller from depth information of the part of the person extracted from the captured images.

7. The monitoring system according to claim 6 wherein the depth information is derived from a measure of the brightness of the part of the person in the images.

8. The monitoring system according to claim 6 wherein the brightness is determined from a brightness-distance model.

9. The monitoring system according to claim 6 wherein the depth information is derived from phase information captured by the camera.

10. The monitoring system according to claim 6 wherein the camera is capable of capturing images in three dimensions and the depth information is extracted from the three dimensional images by the controller.

11. The monitoring system according to claim 1 wherein the controller is responsive to the monitoring signal to set the output power of the one or more infrared light sources to one of a plurality of power output levels based on the proximity of the part of the person from the one or more infrared light sources.

12. The monitoring system according to claim 11 wherein the output power levels are determined by an illumination model.

13. The monitoring system according to claim 11 wherein the output power levels are determined by a lookup table stored in a database.

14. The monitoring system according to any one of the preceding claims wherein the controller is responsive to the monitoring signal to issue an alert if the part of the person comes within a predetermined proximity from the one or more infrared light sources.

15. The monitoring system according to any one of the preceding claims wherein the part of the person includes the person's face, eyes, hands or arms.

16. The monitoring system according to claim 1 wherein the output power is controlled based on a determination of radiation safety to the person.

17. The monitoring system according to claim 1 fitted within a vehicle cabin and the person is a driver of the vehicle.

18. (canceled)

19. An illumination system including:
one or more infrared light sources;
a controller for controlling the output power of the one or more infrared light sources; and
one or more proximity detection devices positioned proximal to the one or more infrared light sources and being in electrical communication with the controller, each of the one or more proximity detection devices configured to detect the proximity of an object and, in response, issue a respective monitoring signal to the controller;
wherein, in response to receiving the monitoring signal, the controller selectively adjusts the output power of the one or more infrared light sources.

20. The illumination system according to claim 19 wherein the one or more proximity detection devices include an RF proximity sensor device.

21. The illumination system according to claim 19 wherein the one or more proximity detection devices include a camera having range estimation capability.
